(19) United States
(12) Patent Application Publication
(10) Pub. No.: US 2008/0126352 A1
(43) Pub. Date: May 29, 2008

(54) CLIENT SIDE STATE CACHE FOR INDUSTRIAL CONTROL SYSTEMS

(75) Inventor: Clark L. Case, Phoenix, AZ (US)

Correspondence Address: ROCKWELL AUTOMATION, INC./(AT), ATTENTION: SUSAN M. DONAHUE, E-7F19, 1201 SOUTH SECOND STREET, MILWAUKEE, WI, 53204, US

(73) Assignee: ROCKWELL AUTOMATION TECHNOLOGIES, INC., Mayfield Heights, OH (US)

(21) Appl. No.: 11/535,745

(22) Filed: Sep. 27, 2006

(51) Int. Cl. G06F 17/30

(52) U.S. Cl. 707/10; 707/E17.032

(57) ABSTRACT

An interface for an industrial automation system is provided. This includes an interface component to interact with one or more applications of a control system, where the applications of the control system are accessed over a network. A cache component stores one or more states associated with the applications to mitigate redundant data exchange over the network.

### TECHNICAL FIELD

The subject invention relates generally to industrial control systems and more particularly to a component that captures state information from remote applications, where the state information is cached between pages of an application or between applications to conserve bandwidth and to facilitate security for remote network interactions.

### BACKGROUND

Industrial controllers historically have operated in factory networks where a plurality of controllers and associated I/O modules communicate. These lower level control elements are often in communication with higher level computing systems or servers that aggregate data from the controllers and help to manage day-to-day activities of an enterprise. As systems have become more complex however, communications and functional cooperation between control system components has become a challenge. Functional cooperation is apparent in remote web applications in one example, where controllers or interactions with control system components are commenced across public networks such as the Internet or across corporate private networks. Generally, these applications require some form of communications between a remote component serving the application and an application such as a client browser (or other interface) that employs data and/or other components of the application. These remote serving elements may include web servers serving some aspect of a control system such as inventory systems, company databases, batch servers, and even control system components themselves such as controllers adapted to serve data over Ethernet for example.

One application where remote systems and interfaces for control systems are becoming predominant includes interactions and control within a larger Manufacturing Execution System (MES). The MES can include the need for users and components of an enterprise to communicate across networks (or network layers) to exchange data between various serving elements of the data and components that employ such data in one or more operations of the enterprise. To name but a few example areas or layers where such components may communicate, these examples include lower level control system components, engineering systems, materials systems, inventory systems, production tracking systems, quality systems, scheduling systems, and so forth.

Each of the respective areas for the enterprise can include individual components that have differing communications requirements. For example, engineering systems may include Part List components, Process Routings components, Bill of Materials components, Multi-Out Production components, Customer Part Numbers, Manufacturing Masters, CAD Integration, components and so forth. Materials systems on the other hand may include Raw Material Specifications, Raw Material Receiving components, and Part-Materials (BOM), for example. Similarly, inventory tracking can include Physical/Cycle Inventory, Subcontract Shipping/Receiving, Customer/Consignment Inventory, Lot Tracking, Scrap Tracking, Rejection Tracking, Serialized Individuals Inventory, Container Types, Returnable Container Tracking, and Inventory Location Lists, for example. Similar to these areas, production tracking systems, quality systems, scheduling systems and the like can be broken into a plurality of management components required to perform tasks for a given area of the enterprise. As can be appreciated, each of the respective enterprise areas and management components can include diverse interface, security, and remote database access considerations.

In order to run a respective enterprise, communications between these diverse components can occur over local and/or public networks where large amounts of data can be exchanged. Such communications also occur over various layers of the enterprise such as between a controller at a factory layer and a manufacturing database on an upper tier of the enterprise. Generally, there are at least two requirements for remote data exchanges between components of an application. These include the ability to exchange data in an efficient manner where data is communicated as fast as possible and includes the requirement that data exchanges are conducted in a substantially secure environment. Presently, certain types of data have to continually be reloaded over the remote connection as pages of an application are accessed or as different applications are accessed. This type of reloading causes network performance to suffer and can pose a security risk to the enterprise.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Systems and methods are provided to capture state information during remote web application interactions from various locations in a control system or enterprise. In one aspect, a client side object (or objects) employs a local cache to capture state information associated with a server program, where the state information is captured and maintained on the client side when application views associated with the server are changed on the client. State information can also be maintained as different applications are selected or changed. By capturing state information associated with a remote application in this manner (e.g., at the client), performance can be enhanced, where the captured information mitigates having to continually reload data from the server to the client or remote programs. The captured information at the client also increases overall security in the system by mitigating the amount of confidential data that is exposed over the network since remote applications can be developed that no longer seek to reload as much information during execution of the respective application.

The cache component that is maintained on the client can be associated with various aspects of component data exchange to maintain state and thus mitigate the amount of data exchanged during execution of the application. Basic cache components can include security information, links between pages of an application, links between applications, access limitation rules, application states, and so forth. The cache components can also store states associated with basic network interface elements that also communicate with the cache such as WSDL, SOAP, JAVA, HTML components, and access control lists, for example. Generally, security components that may be interfaced with include authentication or encryption components where state aspects from authentication procedures can be stored and exchanged between applications or components thereof. Such security information can be reemployed with other application components that may also utilize such information. Other cache interactions include client-side user interface components and how interactions with such interfaces can be identified and maintained for further use via the cache.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a state cache and interface for an industrial automation system.

FIG. 2 is a diagram illustrating example industrial applications that can be employed with a cache component.

FIG. 3 is a diagram illustrating example cache components.

FIG. 4 is a diagram illustrating example security components that can operate with a cache.

FIG. 5 is a diagram illustrating example network protocol components operating with a cache.

FIG. 6 is a diagram illustrating example network interface components operating with a cache.

FIG. 7 is a diagram illustrating and example control system and user interface operating with a cache.

FIG. 8 is a diagram illustrating alternative data components that can be stored with a cache.

FIG. 9 is a flow diagram illustrating a state cache process for control system network interactions.

FIG. 10 illustrates a basic computing system that can be employed with a cache component.

FIG. 11 illustrates an example client and server system that can employ a client side cache to maintain application data states.

### DETAILED DESCRIPTION

Systems and methods are provided to facilitate remote data exchanges between remote server applications and one or more client components of a control system. In one aspect, an interface for an industrial automation system is provided. This includes an interface component to interact with one or more applications of a control system, where the applications of the control system are accessed over a network such as the Internet. A cache component stores one or more states associated with the applications to mitigate redundant data exchange over the network. By caching information at the interface, control system security can be enhanced since the need to exchange confidential information over the network is mitigated. This also facilitates better performance over the network since less information has to be exchanged.

It is noted that as used in this application, terms such as “component,” “application,” “page,” “cache,” and the like are intended to refer to a computer-related entity, either hardware, a combination of hardware and software, software, or software in execution as applied to an automation system for industrial control. For example, a component may be, but is not limited to being, a process running on a processor, a processor, an object, an executable, a thread of execution, a program and a computer. By way of illustration, both an application running on a server and the server can be components. One or more components may reside within a process and/or thread of execution and a component may be localized on one computer and/or distributed between two or more computers, industrial controllers, and/or modules communicating therewith.

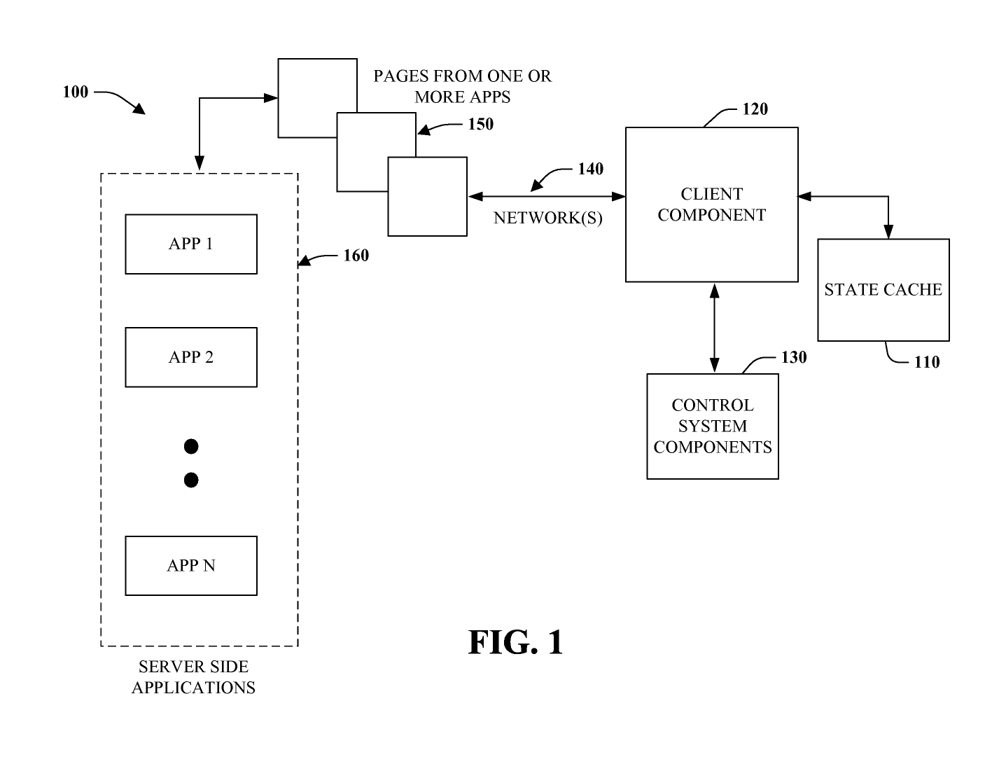

Referring initially to FIG. 1, a system 100 illustrates a state cache 110 and interface for an industrial automation system. A client component 120 acts as in interface for one or more control system components 130 such as programmable logic controllers, communications modules, user interfaces, and so forth which are described in more detail below. The client component 120 communicates across a network 140 to one or more pages of an application at 150, where the respective pages are associated with one or more server side applications 160. In general, the state cache 110 is employed to temporarily store states associated with the pages 150 or the applications 160 in order to mitigate the amount of data that is transferred across the network 140 during subsequent data exchanges. Such state information can include a plurality of differing data that is maintained by the client component 120 in order that such data does not have to be retransmitted across the network 140.

To illustrate data that is cached at 110, the client component 120 may represent a user interface acting on behalf of the control system component 130 such as a controller. An application 160 residing at a remote web server may include data that is to be exchanged with the client component 120. During a plurality of transactions with a remote database application at 160 for example, the state cache 110 maintains storage of state information in such as manner that allows further transference of the cached information to occur from the state cache as opposed to continually retrieving the data across the network 140. Thus, after initially loading the cache 110 with state information or other data, the cache 110, client component 120, and the applications 160 can cooperate to more effectively serve desired information over the network 140. This type of data that can be cached at 110 can take on a plurality of forms and is described in more detail below. Such data can include for example security data associated with the pages 150 of the application 160. For example, authentication or encryption data that was once obtained, can be cached at 110 and subsequently employed by the client component 120 upon further access of the pages 150 or applications 160 rather than reacquire such information over the network 140. Other types of data that can be acquired and stored by the cache 110 include links to other applications, links between pages of an application, data portions that have been acquired in a secure manner for one application that are subsequently employed for another application and so forth. Such data and interfacing to the data will be described in more detail below.

The applications 160 can be associated with substantially any area of an enterprise and control system. This includes remote database applications, controller programs, controller communications applications, remote web services for exchanging data, alarm services, event services, publish and subscribe services, batch applications including associated recipes or mixtures, and so forth. Still yet other applications 160 include those components of an enterprise that support the control system components. These applications 160 can include Manufacturing Execution Systems (MES) or Enterprise Resource Planning systems (ERP). Such applications 160 such as MES or ERP can include a vast number of component applications that support a plurality of activities of an enterprise and subsequently can have one or more states associated with these applications cached at 110. These respective applications 160 and components thereof can be interfaced via the client component 120 and ultimately have data that is stored in the cache 110 when these components are accessed.

The state cache 110 can be maintained on the client component 120 and can be associated with various aspects of component data exchange to maintain state and thus mitigate the amount of data exchanged during execution of the applications 160. As will be described in more detail below, basic cache components 110 can include security information, links between pages of an application, links between applications, access limitation rules, application states, and so forth. The cache 110 can also store states associated with basic network interface elements that also communicate with the cache over the network such as Web Service Description Language (WSDL), Simple Object Access Protocol (SOAP), JAVA components, HTML components, wireless components, and access control lists, for example. Generally, security components that may be interfaced with include authentication or encryption components where state aspects from authentication procedures can be stored and exchanged between applications 160 or components thereof such as the pages 150. Such security information can be reemployed with other application components 160 that may also utilize such information. Other cache interactions 110 include client-side user interface components and how interactions with such interfaces can be identified and maintained for further use via the cache. Before proceeding, it is noted that in one aspect, an interface for an industrial control system is provided by the system 100. The interface includes means for serving one or more pages of an application (e.g., applications 160) and means for interfacing to the pages of the application (e.g., client component 120). This also includes means for caching control system states at a remote network location (e.g., state cache 110).

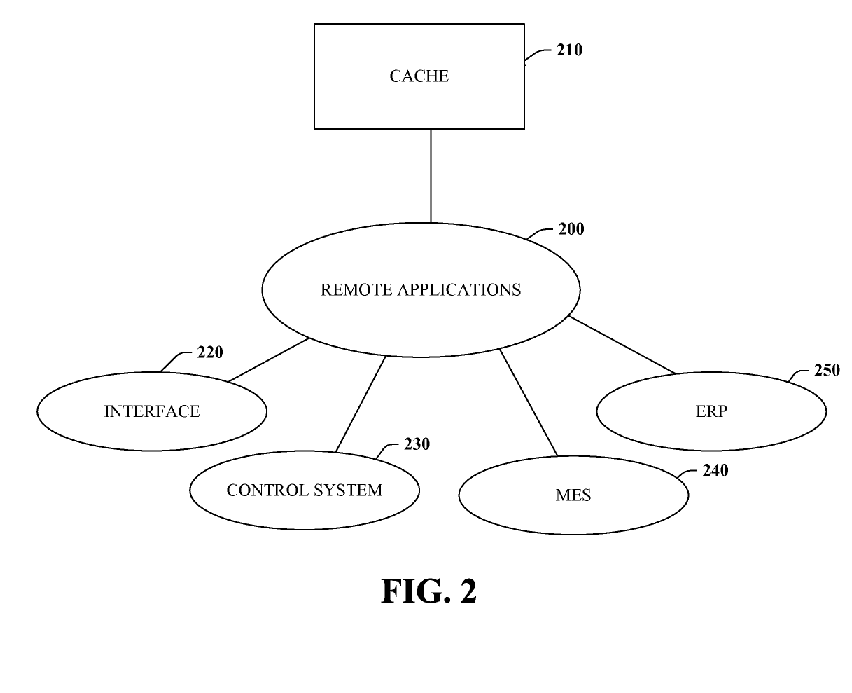

FIG. 2 illustrates example industrial applications 200 that can be employed with a cache 210. Thus, portions of the data exchanged with the respective applications 200 can be stored in the cache 210 to facilitate further interactions with the applications. In one example, the applications 210 include one or more interface applications at 220. These can include control systems interfaces, software panels, design software, simulation tools, communications software, and so forth that interact with various layers of an enterprise such as a control layer, intermediate network layer, or upper tier associated with a database application. At 230, one or more control systems applications can be provided and ultimately exchange data with the cache 210. These applications can include editors, monitoring tools, quality software, maintenance tools, ladder programs, SFC programs, Gant Chart Programs, controller software components, firmware tools, material model tools, and so forth.

At 240, one or more components of a Manufacturing Execution System can be provided and interact with the cache 210. These components 240 can include interfaces and data related to design aspects of an enterprise such as parts lists, material routings, bill of materials, part data bases, CAD databases, material parameters, raw material specification, inventory, and so forth. Inventory tracking components of the MES 240 can include parts traceability components, product genealogy components, inventory tracking components, shipping or receiving components, inventory consignment, lot tracking, scrap tracking, and container information, for example. Production tracking can include control panels, work center tracking, shift data including job tracking and clocking for employees. Still yet other MES components 240 can include PLC/Machine integration data, settings/recipes, quality components, regulatory tracking and data capture, inspection data, scheduling information, production requirements planning software (PRP), Advanced Production Scheduling (APS), or Material Requirements Planning (MRP) software.

At 250, Enterprise Resource Planning (ERP) software can be provided that interfaces with the cache 210. The ERP software 250 attempts to integrate substantially all departments and functions across a company onto a singular computer system (or reduced subset of components) that can serve all components of an enterprise's particular needs. Each department in an ERP system typically has its own computer system optimized for the particular ways that the department performs its work or tasks. ERP combines these resources together into an integrated software solution that runs off a single database (or reduced subset of databases) so that the various departments can more easily share information and communicate with each other. In general, ERP vanquishes the old standalone computer model serving the factory floor, finance, HR, manufacturing and the warehouse, and replaces them with a unified software program divided into software modules that roughly approximate the standalone models.

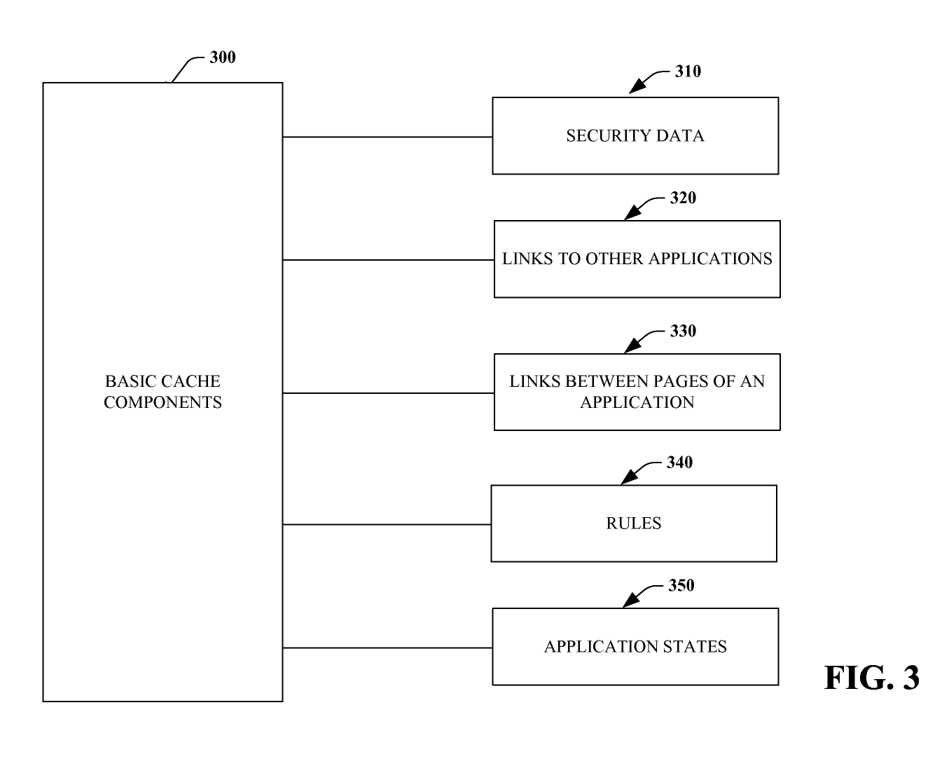

Referring now to FIG. 3, basic cache components 300 are illustrated that cooperate with remote server applications in an industrial control system. In one aspect, the cache component 300 includes one or more security components 310 that may interact with the cache such as storing one or more security states or elements in the cache 300. This can include user identification data, passwords, encryption information, verification states, security states, digital signature data, and substantially any state associated with executing a subsequent page or application in accordance with the stored security data in cache. At 320, one or more links to other applications may be stored. This can include addresses or procedure calls that allow cache data to be employed with subsequent applications identified by the links.

At 330, links between pages of an application can be provided. Similar to application links, such links identify components or elements of an application that can subsequently employ state data that has been previously cached at the client or other remote control system component. At 340, one or more rules or policies may be cached. This may include rules for defining how long cache data can be utilized, a time of day where cache data may in fact be employed, rules for automatically clearing the cache, and limitation rules such as subsequent applications or links that may not be suitable for use with the cache. As can be appreciated, rules can be enabling or defined as limitations. For example, an enabling rule may specify that a certain address range for data can be cached where subsequent access from the data is to be retrieved from the cache as opposed to retrieval over the network. At 350, one or more application states are stored in the cache. This includes substantially any data, tag, or flag that indicates the previous states or state of an application.

By employing such state data, when the application changes states from one to another, previous states that have been achieved can be recreated from the cache as opposed to re-building the state or application from the server side across the network. As can be appreciated, the state of an application can be related to the state of a state machine such as a PLC program or instruction, batch, phase, or recipe state. State can also reflect the condition of an application such as the states that were stored during the last three pages of the application that were downloaded. State can also reflect residue from previous applications such as security information that is employed as applications are switched at the remote server.

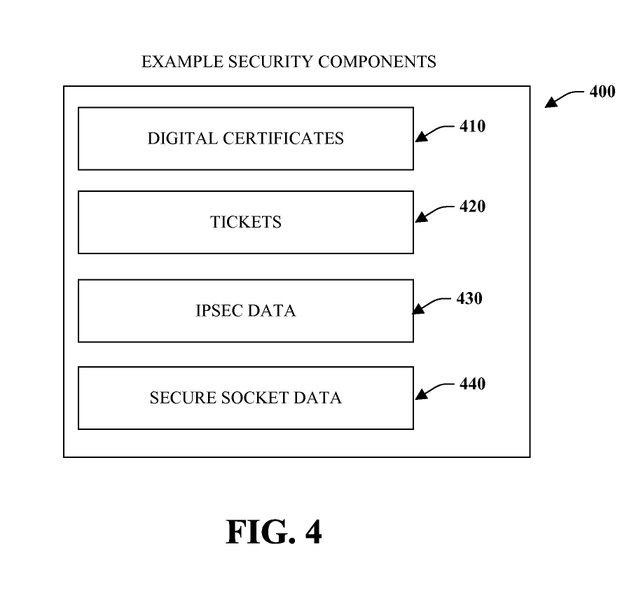

Referring to FIG. 4, example security components 400 are illustrated that may have one or more data aspects stored in a cache. In many cases, before users can gain access to an application, a trust relationship is established between the remote system and the user or other component. This may also include a policy component such as an Internet Key Exchange (IKE) component. According to one aspect, the trust may be established according to the Public Key Infrastructure (PKI) and is generally defined by the Internet Engineering Task Force (IETF). At 410, a digital certificate may be issued to or from a client component from a server component that defines the trust relationship with the remote system. The certificate 410 may include such information as an identifier field, a public key field, a serial number (of the certificate) activation, expiration date and digital signature field, where these and/or other fields can be stored in a cache. In accordance with an alternative aspect, Kerberos may be employed to facilitate the trust relationship. Kerberos operates by providing principals (e.g., users or services) with tickets 420 that may be utilized to identify principals. The tickets 420 provide a cryptographic sequence of bytes to facilitate the trust relationship. Other aspects that may be accessed from the cache include permissions such as what a logged in user is permitted to perform and otherwise not permitted to perform.

In conjunction with establishing the trust relationship, a substantially secure data channel can be provided between the remote system and the client components interacting therewith. This may include providing an Internet Protocol Security (IPSEC) protocol 430 that may be employed to provide substantially secure data between remote systems and the client, where one or more aspects of the protocol or data exchange employing the protocol can be cached. In general, IPSEC facilitates private and secure communications over public communications channels such as the Internet. By utilizing IPSEC, security issues associated with conventional control systems are mitigated. According to an alternative aspect, a Secure Sockets Layer (SSL) protocol 440 specified by the IETF, may be employed between the remote server and the client. A goal of the SSL Protocol is to provide privacy and reliability between two communicating applications.

The SSL protocol can be composed of two layers, for example. At the lowest level, layered on top of a common transport protocol (e.g., TCP[TCP]), is an SSL Record Protocol. The SSL Record Protocol is employed for encapsulation of various higher-level protocols. One such encapsulated protocol, an SSL Handshake Protocol, enables the first and second system to authenticate each other and to negotiate an encryption algorithm and cryptographic keys before an application protocol transmits or receives its first byte of data. An advantage of SSL is that it is application protocol independent. It is noted that a higher-level protocol can layer on top of the SSL or IPSEC Protocol transparently.

To provide one example of a secure data exchange, a user access-request (e.g., remote request to access controller resources) may be received from the user or remote system and directed to a processor to authenticate and authorize the user via an encrypted data channel. After the remote system and/or user has been authenticated and authorized, the user or system can then be permitted access to the controller, for example. During such exchanges, portions of security data can be cached on the client side to mitigate further exchanges of such data with the remote server. It is noted that authentication refers to a determination that a purported user or system is whom they claim to be. Authorization is a process of verifying that a user or system has been authorized by the client to access resources. It is further noted that authorization can include enabling partial and/or constrained access to one or more portions of an application. For example, a controller may desire to limit access of confidential data locations from designated users who may need only access a portion of the resources, yet enable the designated user access to other resources or portions thereof. Such access limitations or restrictions can similarly be cached at the controller.

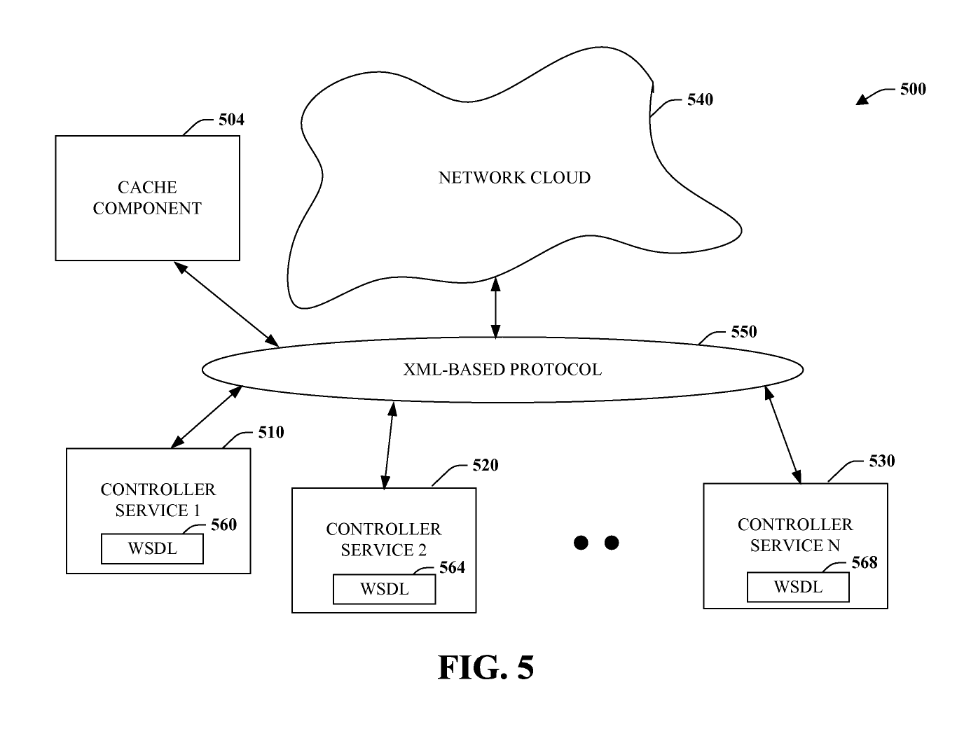

Referring now to FIG. 5, a system 500 illustrates example network protocols that can interact with a cache component 504. A plurality of controller services 510 through 530 interact with a network cloud 540 via an XML-based protocol 550. The protocol 550 is typically an open standard defined for use on public communications systems such as the Internet. In one aspect, a Simple Object Access Protocol (SOAP) 550 can be employed as a communications protocol for XML Web services and subsequently interact with the cache 504. SOAP is an open specification that defines an XML format for messages between services. The specification can include describing how to represent program data as XML and how to utilize SOAP to perform Remote Procedure Calls. These optional parts of the specification are employed to implement Remote Procedure Call (RPC)-style applications, wherein a SOAP message containing a callable function, and the parameters to pass to the function, is sent from a client such as a control system, and the server returns a message with the results of the executed function.

Most current implementations of SOAP support RPC applications since programmers who are familiar to COM or CORBA applications understand the RPC style. SOAP also supports document style applications whereby the SOAP message is provided as a wrapper around an XML document. Document-style SOAP applications are very flexible, wherein a control system XML Web service can take advantage of this flexibility to build controller services that may be difficult to implement with RPC. Other parts of the SOAP specification define what an HTTP message that contains a SOAP message may appear as. HTTP binding can be important because HTTP is supported by almost all current operating systems.

The controller services 510 through 530 can also employ an open interface standard such as a Web Service Description Language (WSDL) illustrated at 560 through 568 in order to provide interactions with the controller services, where such interactions can involve caching operations for the remote application. In general, a WSDL file or interface is an XML document that describes a set of SOAP messages and how the messages are exchanged. In other words, WSDL 560-568 is to SOAP what Interface Description Language (IDL) is to CORBA or COM. Since WSDL is in XML format, it is readable and editable but in most cases, it is generated and consumed by software. WSDL specifies what a request message contains and how the response message will be formatted in unambiguous notation. As an example, an I/O service can specify how inputs are to be requested from the service and how outputs can be sent to the service in the form of a response. In another aspect, inputs can be requested from an input service, wherein the response is a confirmation that the inputs were received. Outputs can be sent to an output service in the form of a request, wherein the response from the service is that the outputs were received.

The notation that a WSDL file utilizes to describe message formats is based on an XML Schema standard which implies it is both programming-language neutral and standards-based which makes it suitable for describing XML Web services interfaces that are accessible from a wide variety of platforms and programming languages. In addition to describing message contents, WSDL defines where the service is available and what communications protocol is employed to communicate to the service. This implies that a given WSDL file defines substantially all matters required to write a program to work with an XML Web service.

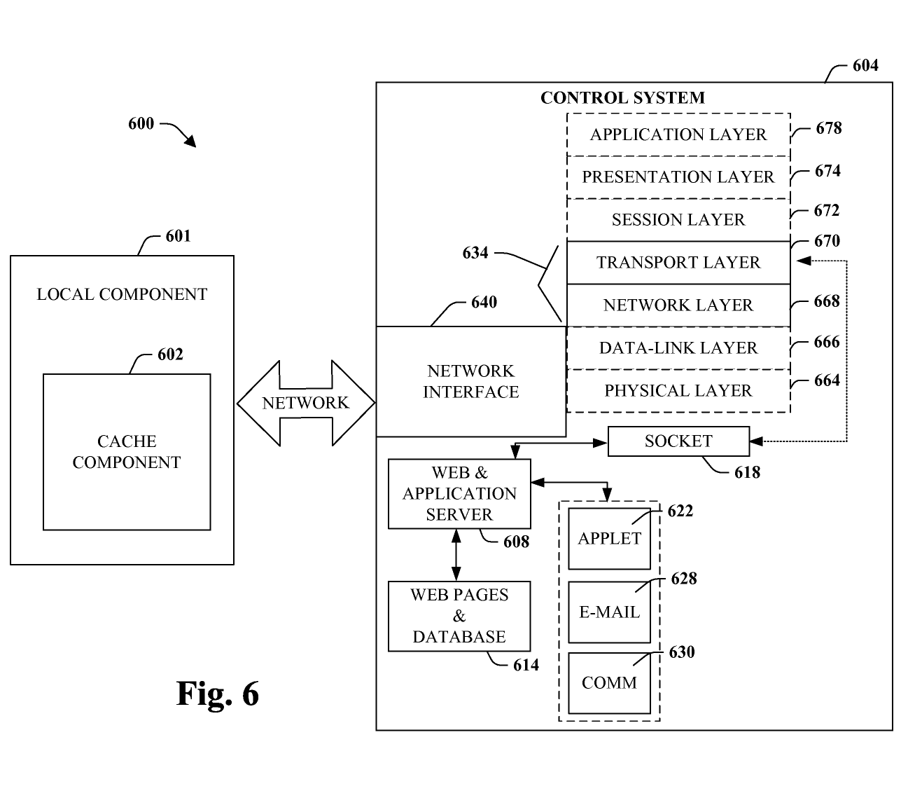

Referring to FIG. 6, a system 600 illustrates example network interface components that can interface with a local component 601 having a cache component 602. A control system 604 may include a web server 608 that provides information exchange with a remote system (not shown) associated with the cache component 602. The remote system may include a browser (not shown) that communicates with the web server 608. It is noted that similar components as shown in the control system 604 can reside in the remote system and subsequently provide data to the cache component 602. Controller information may be exchanged via web pages and/or content included within a database 614 associated with the web server 608. Web content may include but is not limited to such technologies as HTML, SHTML, VB Script, JAVA, CGI Script, JAVA Script, dynamic HTML, PPP, RPC, TELNET, TCP/IP, FTP, ASP, XML, PDF, WML as well as other formats. The browser, which can reside in the remote system or other control systems, communicates with the web server 608 via one or more sockets 618 and loads one or more objects such as an applet 622.

It is noted that each object or applet 622 may be associated with one or more sockets 618 that can also generate states or data that can be stored on the cache component 602. As an example, the browser may load a web page or other application from the server 608 via a public domain or standard socket such as a Hyper Text Transfer Protocol (HTTP) socket, a File Transfer Protocol (FTP) socket, a Simple Mail Transfer Protocol (SMTP) socket, a Remote Procedure Call (RPC) socket, a Remote Method Invocation (RMI) socket, a Java Database Connectivity (JDBC) socket, an Open Database Connectivity (ODBC) socket, a Secure Sockets Layer (SSL) socket, a Network File System (NFS) socket, a Windows socket such as Winsock, a Point-of-Presence 3 (POP3) socket and a TELNET socket.

Along with the applet 622 for serving the browser, the web server 608 may invoke other objects or programs for interfacing to a control system. For example, these programs may include an e-mail component 628 for sending unsolicited and/or other messages to the remote system. A communications component 630 may be provided to transfer files to or from the database 614. For example, a File Transfer Protocol (FTP) component may be provided to transfer files. The socket 618 interfaces with a TCP/IP stack 634 that may be associated with several layers. The layers transfer data to and from a network interface 640. It is noted that logic from one or more of the layers may be incorporated within the network interface 640 and that more than one socket 618 may be employed to communicate with various objects within the control system 604.

The TCP/IP stack 634 may be associated with one or more other network layers. A physical layer 664 may be provided that defines the physical characteristics such as electrical properties of the network interface 640. A data-link layer 666 defines rules for sending information across a physical connection between systems. The TCP/IP stack 634 may include a network layer 668, which may include Internet protocol (IP), defines a protocol for opening and maintaining a path on the network. A transport layer 670 associated with the TCP/IP stack 634, may include Transmission Control Protocol (TCP) that provides a higher level of control for moving information between systems. This may include more sophisticated error handling, prioritization, and security features, for example. A session layer 672, presentation layer 674, and application layer 678 may also be optionally included that sit above the TCP/IP stack 634. It is noted that the server 608 can be a web server or an HTTP server, wherein an application loaded from the control system 604 to the remote system can be a Java applet or a Java application, for example, where portions of state data associated with such applications can be stored in the cache component 602.

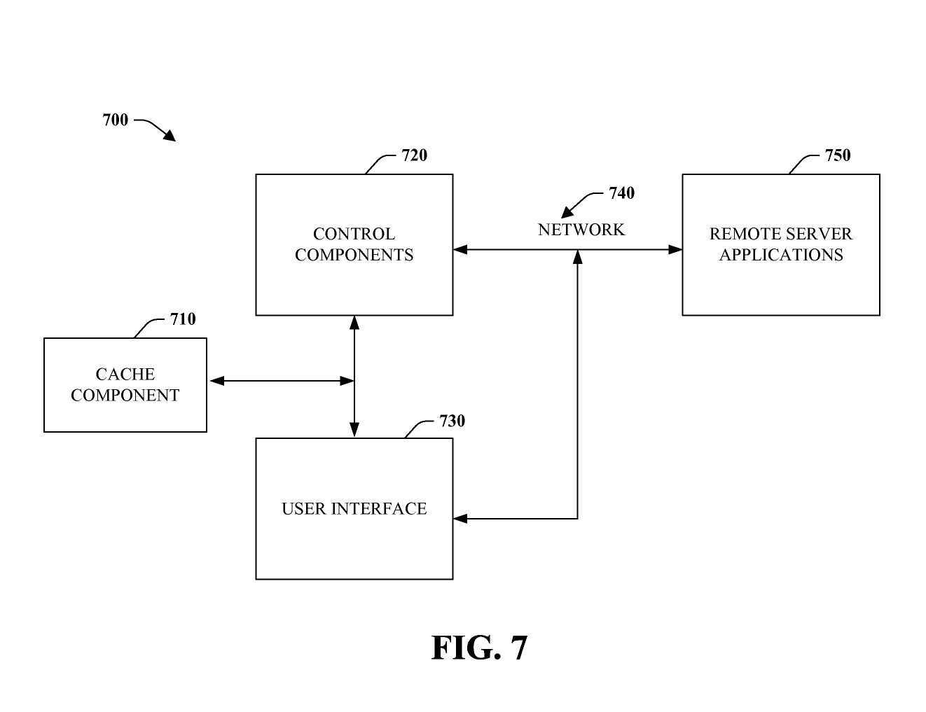

FIG. 7 illustrates an example system 700, network and user interface that can be employed with a cache 710. As shown, the cache 710 can interact with one or more control components 720 and user interface 730. The control components 720 and interface 730 can communicate across a network 740 with one or more remote server applications. The control components 120 can include various computer or network components such as servers, clients, programmable logic controllers (PLCs), communications modules, mobile computers, wireless components, control components and so forth which are capable of interacting across the network 740. Similarly, the term PLC as used herein can include functionality that can be shared across multiple components, systems, and or networks 740. For example, one or more PLCs can communicate and cooperate with various network devices across the network 740. This can include substantially any type of control, communications module, computer, I/O device, sensor, Human Machine Interface (HMI)) such as the user interface 730 that communicate via the network 740 which includes control, automation, and/or public networks. The PLC can also communicate to and control various other devices such as Input/Output modules including Analog, Digital, Programmed/Intelligent I/O modules, other programmable controllers, communications modules, sensors, output devices, and the like.

The network 740 can include public networks such as the Internet, Intranets, and automation networks such as Control and Information Protocol (CIP) networks including DeviceNet and ControlNet. Other networks include Ethernet, DH/DH+, Remote I/O, Fieldbus, Modbus, Profibus, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

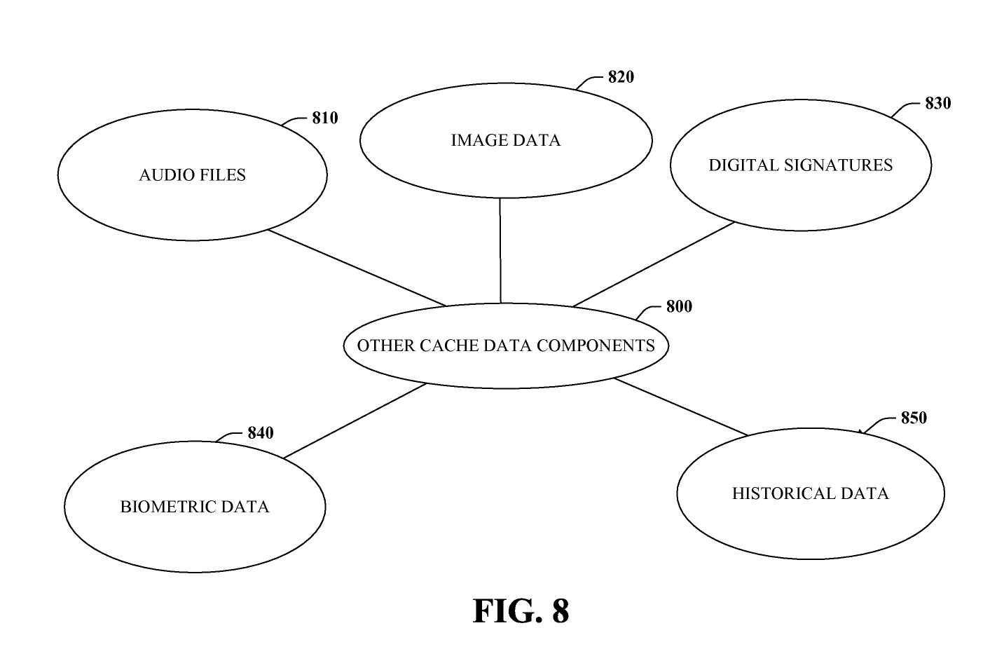

FIG. 8 illustrates alternative data components 800 that can be cached in an industrial automation system. At 810, state data can include one or more audio files that can potentially be cached. For example, an audio portion that was to be replayed as a system alarm across multiple interfaces. Similarly, an audio recording of a voice may be cached in order to work with one or more applications. At 820, cache data can also include image or visual data. This can include series of images that form a scene or other communication. Such image data 820 can be cached and subsequently employed across other pages of an application or between applications as noted above. At 830, one or more digital signatures can be cached on the client side of an application. Such signatures can be used throughout and across applications to verify or authenticate various components or procedure in an application. At 840, similar to digital signature data 830, biometric information may be cached to further facilitate authentication procedures across application components. This can include such items as fingerprint and retinal scan data at 840. These components 840 can also include audio data for voice recognition and video data for facial recognition. At 850, historical data may be cached. This can include data that is collected over a period of time and is employed as part of maintaining compliance with one or more regulatory procedures.

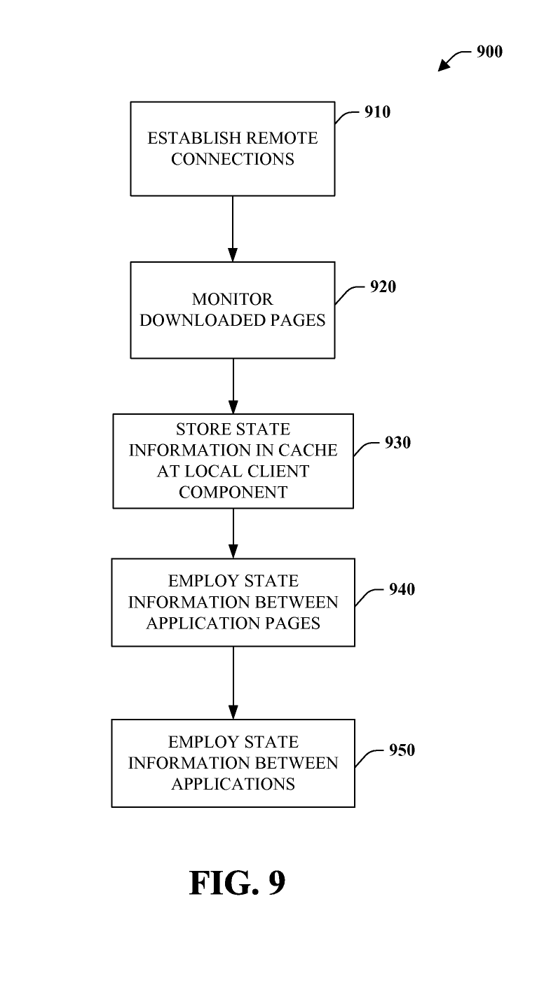

FIG. 9 illustrates a state cache process 900 for an industrial automation system. While, for purposes of simplicity of explanation, the methodology is shown and described as a series of acts, it is to be understood and appreciated that the methodology is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as described herein.

Proceeding to 910 of FIG. 9, a remote connection is established between at least one client component and an application served across a network. The client component could include an application such as a user interface that interacts with an element of a control system or could include a component such as a controller or communications module for example. At 920, as interactions with the remote application occur, various states are monitored or tracked. Such states can include data that has been previously loaded during execution of the application. At 930, the state data that has been monitored is cached at the client component. The cache can include a local high speed memory element that can quickly save data sent to it from the local machine.

At 940, the data cached at 930 is employed between pages of the remote server application. Thus, when state information has been cached at 930, upon further execution of the remote application, and when similar state data is requested that has been previously cached, the data can be retrieved locally from the client component while mitigating the need to reload such data from the remote server. At 950, as applications are changed at the remote server, cached data can be employed between applications in some cases. For example, it is possible to employ security data that has been previously retrieved with a previous application in a subsequent application that also shares a need for the security data.

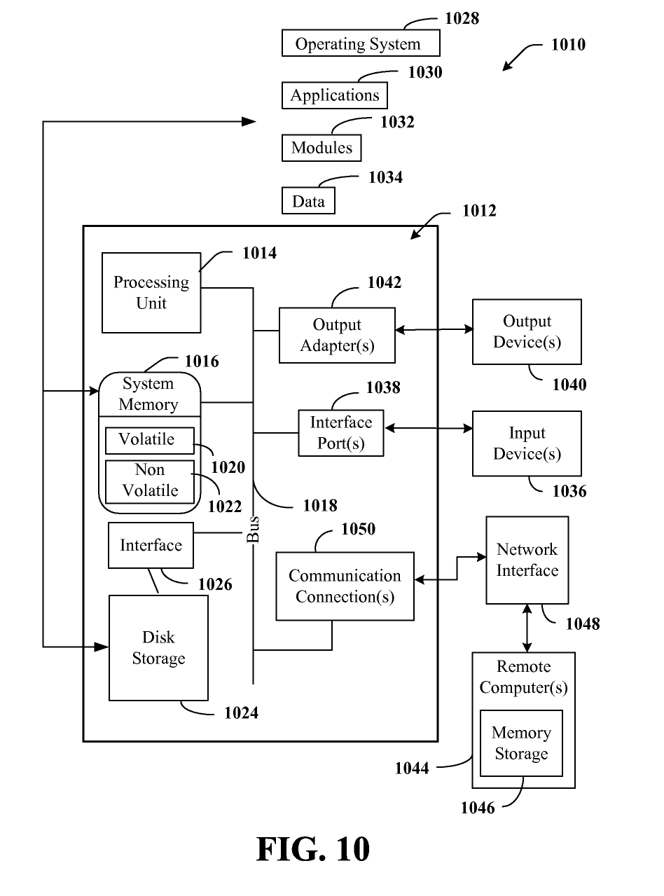

With reference to FIG. 10, an exemplary environment 1010 for implementing various aspects described herein includes a computer 1012. The computer 1012 includes a processing unit 1014, a system memory 1016, and a system bus 1018. The system bus 1018 couple system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that various components described herein can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like monitors, speakers, and printers, among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

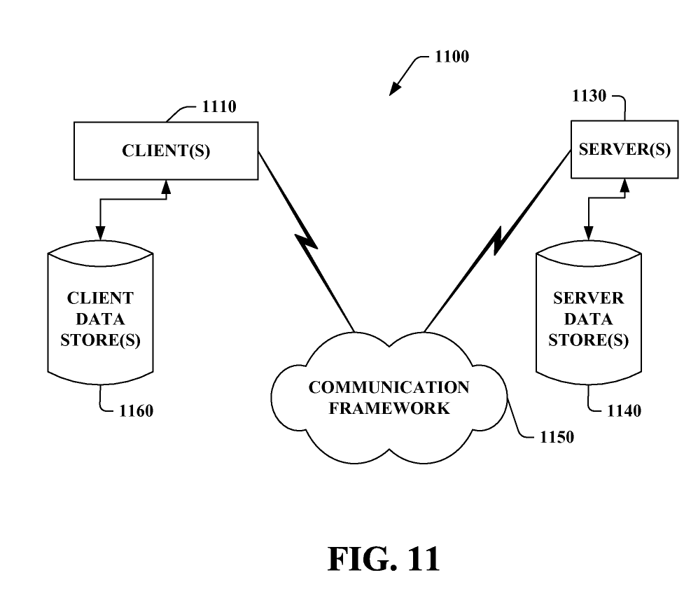

FIG. 11 is a schematic block diagram of a sample-computing environment 1100 that can be employed. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the components described herein, for example. One possible communication between a client 1110 and a server 1130 may be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An interface for an industrial automation system, comprising:
an interface component to interact with one or more applications of a control system, the applications of the control system are accessed over a network; and
a cache component to store one or more states associated with the applications to mitigate redundant data exchange over the network.

2. The interface of claim 1, the interface component is associated with at least one client component, the client component associated with at least one control component.

3. The interface of claim 2, the control component is associated with a programmable logic controller, a communications module, an I/O module, and a user interface.

4. The interface of claim 1, the interface component communicates to one or more pages of an application, where the pages are associated with one or more server side applications.

5. The interface of claim 1, the applications include a Manufacturing Execution System (MES) and an Enterprise Resource Planning System (ERP).

6. The interface of claim 5, the MES further comprises production requirements planning software (PRP), Advanced Production Scheduling (APS) software, or Material Requirements Planning (MRP) software.

7. The interface of claim 1, the cache component stores data relating to a security component.

8. The interface of claim 7, the security component is associated with at least one of a digital certificate or a digital ticket.

9. The interface of claim 7, the security component employs an Internet protocol security component.

10. The interface of claim 7, the security component employs a secure socket layer protocol.

11. The interface of claim 1, the cache component is associated with at least one link to an application.

12. The interface of claim 1, the cache component is associated with at least one link to at least one page of an application.

13. The interface of claim 1, the cache component is associated with at least one rule that outlines a procedure for when to employ cache data with an application.

14. The interface of claim 1, the interface component is associated with at least one Internet protocol.

15. The interface of claim 14, the Internet protocol is associated with a Simple Object Access Protocol (SOAP).

16. The interface of claim 14, the interface component is associated with at least one web service.

17. The interface of claim 16, the web service is associated with a web services description language (WSDL).

18. The interface of claim 1, the interface component is associated with at least one network layer.

19. The interface of claim 1, the cache component stores audio or image data.

20. The interface of claim 1, the cache component stores digital signature data.

21. The interface of claim 1, the cache component store s biometric data.

22. The interface of claim 1, the cache component stores historical data associated with a regulatory application.

23. A computer readable medium having computer executable instructions stored thereon to facilitate remote network interactions in an industrial automation environment, comprising:
defining at least one interface for a control system component;
coupling the interface to a remote network application serving the control system component;
monitoring data loaded form the remote network application; and
caching a subset of the data loaded form the remote network application, the subset of data employed in other components of the remote network application.

24. The computer readable medium of claim 23, the subset of data employed in at least one other remote network application.

25. A method to interface industrial control components, comprising:
providing an interface for a client component associated with a control system;
communicating to a network application via the client component; and
storing control system states associated with the network application on the client component.

26. The method of claim 25, further comprising storing the control system states in a client side cache.

27. The method of claim 25, the control system states associated with pages of an application.

28. The method of claim 27, the control system states associated with a state machine.

29. The method of claim 27, the control system states associated with a logic program, a batch program, a phase, or a recipe.

30. The method of claim 27, the control system states are associated with a security component.

31. An interface for an industrial control system, comprising:
means for serving one or more pages of an application;
means for interfacing to the pages of the application; and
means for caching control system states at a remote network location.
